(19) United States
(12) Patent Application Publication
(10) Pub. No.: US 2010/0294986 A1
(43) Pub. Date: Nov. 25, 2010

(54) SUPERCRITICAL FLUID FACILITATED PARTICLE FORMATION IN MICROFLUIDIC SYSTEMS

(75) Inventors: Mahmooda Sultana, Cambridge, MA (US); Samuel Marre, Talence (FR); Soubir Basak, Belmont, MA (US); Klavs F. Jensen, Lexington, MA (US)

Correspondence Address: WOLF GREENFIELD & SACKS, P.C., 600 ATLANTIC AVENUE, BOSTON, MA, 02210-2206, US

(73) Assignee: Massachusetts Institute of Technology, Cambridge, MA (US)

(21) Appl. No.: 12/468,422

(22) Filed: May 19, 2009

(51) Int. Cl. C09K 3/00

(52) U.S. Cl. 252/182.12

(57) ABSTRACT

The use of supercritical fluids in the production of particles in microfluidic systems is generally described. Small particles with narrow particle size distributions are useful in a wide range of applications. Submicron and micron-sized organic particles may exhibit enhanced properties such as, for example, increased dissolution rates, enhanced pharmaceutical efficacy, and ease of suspension in a carrier medium. Small organic particles may be particularly useful in drug delivery, exhibiting enhanced performance as inhalation aerosols, injectable suspensions, controlled release dosage drugs, transdermally delivered drugs, and the like.

Supercritical fluids exhibit unique transport properties such as the ability to simultaneously diffuse through solids (e.g., like a gas) and dissolve materials (e.g., like a liquid). Moreover, supercritical fluids are generally low in viscosity, enabling an enhanced ability to mix with other fluids, for example, upon transitioning from a supercritical to a non-supercritical state. The inventors have unexpectedly discovered that, when used in combination with microfluidic systems, supercritical fluids may be used to continuously and controllably nucleate particle precursor materials to produce, in some embodiments, nano- and microscale particles.

### GOVERNMENT FUNDING

Research leading to various aspects of the present invention were sponsored, at least in part, by the Army Research Office under Grant No. W911NF-07-D-0004. The U.S. Government has certain rights in the invention.

### FIELD OF INVENTION

Supercritical fluid facilitated production of particles in microfluidic systems is generally described.

### BACKGROUND

The ability to control the size distribution and structure of nano- and micro-scale particles is of great interest in fields such as the specialty chemical, cosmetic, nutraceutical and, pharmaceutical industries. Submicron and micron-sized particles may be easier to dissolve than larger particles, which may lead to increased bioavailability. For example, the rate of delivery of poorly water-soluble drugs, which may be limited by the rate of dissolution, can be enhanced by producing small particles of such drugs. Also, fine particles with narrow size distributions may exhibit enhanced pharmaceutical efficacy, thus reducing side effects.

Traditionally, the production of small organic particles has been performed using macroscale devices, which may be disadvantageous for several reasons. Macroscale systems may have non-uniform process conditions across the reactor, producing particles with large dispersion. Macroscale systems may also produce a relatively large amount of waste. In addition, macroscale devices can be expensive to operate when using expensive reactants or producing expensive products. The handling of dangerous chemicals or operation at extreme conditions (e.g., high pressure, high temperature, etc.) in macroscale systems can also pose safety risks.

Accordingly, improved systems and methods are needed.

### SUMMARY OF THE INVENTION

The embodiments described herein generally relate to systems and methods for microfluidic production of particles using supercritical fluids. The subject matter of the present invention involves, in some cases, interrelated products, alternative solutions to a particular problem, and/or a plurality of different uses of one or more systems and/or articles.

In one aspect, a method is described. In one set of embodiments, a method of forming organic particles comprises flowing a first fluid containing an organic particle precursor within a microfluidic channel, and flowing a second fluid within the microfluidic channel such that the second fluid contacts the first fluid in the microfluidic channel to form organic particles. In some embodiments, at least one of the first fluid and the second fluid is a supercritical fluid, and after contact, the first and second fluids remain flowing in a microfluidic channel.

In some embodiments, the method comprises flowing a supercritical fluid within a microfluidic channel, mixing the supercritical fluid with a second fluid within the microfluidic channel to produce a mixed fluid, and flowing the mixed fluid within the microfluidic channel.

In some embodiments, the method comprises flowing a fluid containing an organic particle precursor within a microfluidic channel; changing at least one condition such that the fluid crosses a threshold involving a supercritical state, resulting in the formation of organic particles; and flowing the particles within the microfluidic channel.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D include schematic illustrations of devices, according to one set of embodiments;

FIG. 2 includes, according to one set of embodiments, a map of operating regimes on a plot of pressure versus temperature;

FIGS. 3A-3C include schematic illustrations of devices, according to one set of embodiments; and

FIGS. 4A-4B include micrographs of particles, produced according to one set of embodiments.

### DETAILED DESCRIPTION

The use of supercritical fluids in the production of particles in microfluidic systems is generally described. Small particles with narrow particle size distributions are useful in a wide range of applications. Submicron and micron-sized organic particles may exhibit enhanced properties such as, for example, increased dissolution rates, enhanced pharmaceutical efficacy, and ease of suspension in a carrier medium. Small organic particles may be particularly useful in drug delivery, exhibiting enhanced performance as inhalation aerosols, injectable suspensions, controlled release dosage drugs, transdermally delivered drugs, and the like.

Supercritical fluids exhibit unique transport properties such as the ability to simultaneously diffuse through solids (e.g., like a gas) and dissolve materials (e.g., like a liquid). Moreover, supercritical fluids are generally low in viscosity, enabling an enhanced ability to mix with other fluids, for example, upon transitioning from a supercritical to a non-supercritical state. The inventors have unexpectedly discovered that, when used in combination with microfluidic systems, supercritical fluids may be used to continuously and controllably nucleate particle precursor materials to produce, in some embodiments, nano- and microscale particles.

The systems and methods described herein may find application in a variety of fields. Examples of suitable applications include, for example, the production of fine particles, analysis and controlled production of crystal polymorphs, separation of solutes or isomers through fractional particle formation (e.g., by taking advantage of differences in solubility of precipitated particles at supercritical conditions), and purification of solutes or isomers (by using solvent free supercritical particle formation). The systems and methods described herein may be suitable for use in the nutraceutical, cosmetics (e.g. hydroquinone), specialty chemical (e.g. explosives such as cyclotrimethyle netrinitramine (RDX), cyclotetramethylene tetranitramine (HMX), nitroguanidine—NMP or DMF, 3-nitro-1,2,4-triazol-5-one (NTO)), pigment (e.g. bronze red), and food industries, among others.

As a specific example, the systems and methods described herein may be useful to in the discovery and analysis of different polymorphic crystal forms. Active pharmaceuticals can exist in many different solid forms including multiple polymorphs, solvates, and hydrates. Different solid forms may have different physical and chemical properties that affect the bioavailability, shelf life, toxicity or ease of manufacture. The existence of an unrecognized polymorphic form or a mixture of multiple polymorphic forms in a final product may result in unacceptable batch-to-batch or dose-to-dose variations. The systems and methods described herein offer tools to quickly and safely screen supercritical and near supercritical conditions for the discovery of new polymorphs. By identifying favorable process conditions, final polymorphic form may be controlled in some instances.

The systems and methods described herein provide several advantages over traditional particle production methods. For example, continuous operation allows for high-throughput production of organic particles while providing the ability to adjust system conditions in real time. In continuous particle production, process conditions such as solvent and/or antisolvent composition, inhibitor composition and/or concentration, impurity composition and/or concentration, particle precursor composition and/or concentration, or pH of a fluid can be varied by simply changing the flow rate of different feeds. In addition, temperature and pressure effects can also be screened by collecting products for analysis at different temperature and pressure without having to stop the operation or perform each of the experiments at different conditions separately. This allows for quick identification of preferred process conditions.

Microfluidic systems also include short length scales and high surface to volume ratios, which allow for relatively high heat and mass transfer rates. High rates of heat and mass transfer allow for better control over process conditions (e.g., temperature, concentration, contact mode of the reagents, etc.) which may result in substantially uniform process conditions across the device. Particle size and, in some cases, polymorphic form of organic particles may be very sensitive to synthesis conditions. Thus, the systems and methods described herein have the potential to generate a more uniform distribution of particle size and polymorphic form. Short length scales also allow for laminar flow under most operating conditions. Turbulent operation, on the other hand, may involve high shear rates, which can break up particles and increase particle size distribution.

Moreover, microfluidic systems decrease waste as they require only small to amounts of reactants, which is beneficial when dealing with expensive materials such as pharmaceutical drugs. In addition, microfluidic systems provide safety advantages when operating reactors at supercritical conditions, which often requires high temperatures and/or pressures.

The systems described herein also provide optical access for in situ characterization. The ability to observe the microfluidic channel allows one to confirm that one is operating in the desired regime (e.g., a supercritical regime). In addition, optical access provides the opportunity to integrate other in situ monitoring tools such as light scattering (e.g., for the determination of particle size and size distribution), FT-IR, Raman, and other spectroscopy tools (e.g., for the determination of particle morphology).

In one aspect, methods of forming particles involving a supercritical fluid are described. The method may comprise flowing a fluid containing a particle precursor within a microfluidic channel In some embodiments, the fluid may be in a supercritical state or a non-supercritical state upon entering the channel. In some embodiments, at least one condition may be changed such that the fluid crosses a threshold involving a supercritical state (e.g., the fluid transforms from a supercritical state to a non-supercritical state, the fluid transforms from a non-supercritical state to a supercritical state, etc.). Supercritical fluids are well known to those of ordinary skill in the art, and one of ordinary skill could identify conditions that could be changed such that the fluid crosses a threshold involving a supercritical state.

A “particle precursor” refers to any species that forms a particle upon combination with other particle precursor species. Particle precursors may be, for example, suspended or dissolved in a fluid (e.g., a solvent). Particle precursors may be organic or inorganic. As a specific example, in some embodiments, the particle precursor may comprise a protein suspended in a supercritical fluid which, upon combining with one or more other proteins, forms a crystal or an amorphous particle. In some cases, the particle precursor may comprise a polymer that forms an amorphous polymeric sphere upon combination with one or more other polymers.

“Particle formation” is a term that is understood by one of ordinary skill in the art, and is generally used to refer to the process by which material combines to form a solid particle. Particle formation may involve material combination at the molecular scale to form very small particles. For example, one type of particle that may be formed using the systems and methods described herein is a crystal, which is formed upon to nucleation of a crystal precursor material.

In some embodiments, at least one condition is changed which results in the formation of particles. Examples of conditions that may be changed include, for example, the temperature of a fluid or channel, the pressure within a channel, the pH of a fluid, and the like. In some instances, changing the at least one condition such that the fluid crosses a threshold involving a supercritical state may result in the formation of particles. Not wishing to be bound by any theory, the formation of particles in such embodiments may be due to a change in solubility of the particle precursor as the fluid crosses a threshold involving a supercritical state. As a specific example, a non-supercritical fluid containing particle precursor may be flowed within the channel, and at least one condition may be changed resulting in the transition of the fluid from the non-supercritical to the supercritical state. The solubility of the particle precursor may be relatively low in the supercritical state, giving rise to particle formation (e.g., via nucleation). In another example, a supercritical fluid containing particle precursor may be flowed within the channel, and at least one condition may be changed resulting in the transformation of the fluid from the supercritical state to a non-supercritical state. The solubility of the particle precursor may be relatively low in the non-supercritical state, giving rise to particle formation.

As a specific example, a supercritical fluid containing a suspension of proteins may be flowed within a microfluidic channel The cross-sectional area of the channel may increase in the direction of fluid flow, in some cases, causing a drop in pressure. The drop in pressure may be followed by the nucleation of protein crystals from suspension. As another example, the temperature of the fluid may be lowered resulting in the nucleation of protein crystals. In some instances, changing at least one condition may comprise lowering the temperature of the supercritical fluid to a value below its critical temperature. Similarly, changing at least one condition may comprise lowering the pressure of the supercritical fluid to a value below its critical pressure. By lowering the temperature and/or pressure of a supercritical fluid below its critical temperature and/or pressure, the state of the supercritical fluid may be changed from supercritical to near-supercritical or from supercritical to sub-critical, in some embodiments.

In some embodiments, a supercritical fluid is flowed within a microfluidic channel and mixed with a second fluid within the microfluidic channel to produce a mixed fluid. The mixed fluid may be flowed within the microfluidic channel In some to instances, the mixed fluid may remain flowing within a microfluidic channel for some distance. In some embodiments, the length of the microfluidic channel through which the mixed fluid is flowed may be at least about 2 times, at least about 5 times, at least about 10 times, at least about 25 times, at least about 50 times, or at least about 100 times the largest cross-sectional dimension of the microfluidic channel at the point of mixing.

Mixing two fluids may lead to the formation of particles. For example, in some embodiments, a first fluid containing a particle precursor is flowed within a microfluidic channel, and a second fluid is flowed within the microfluidic channel such that the second fluid contacts the first fluid to form particles. In some embodiments, the particles may be formed continuously, which is to say, particle formation may occur while first and second fluids are flowed through the microfluidic channel.

At least one of the first fluid and the second fluid may be a supercritical fluid. Specifically, in some cases the first fluid containing the particle precursor may be supercritical while the second fluid is not. In some embodiments, the second fluid may be supercritical while the first fluid is not. In still other cases both the first and second fluids may be supercritical. Not wishing to be bound by any theory, the use of supercritical fluids may enhance mixing within the system relative to the type of mixing that would occur were none of the fluids supercritical.

The second fluid may optionally comprise an antisolvent. In some embodiments, the antisolvent should be selected such that the antisolvent is soluble in the first fluid or a solvent in the first fluid, but the particle precursor is insoluble in the antisolvent. As a specific example, ethanol may be used as the antisolvent to produce a supersaturated solution of glycine in water. Those skilled in the art will know of suitable antisolvents, or will be able to ascertain such, using only routine experimentation.

A fluid comprising an antisolvent may be used, for example, to increase the level of supersaturation within a mixed fluid. For example, the first fluid may comprise an under-saturated, saturated, or supersaturated solution of particle precursor, and the second fluid may comprise an antisolvent. The first and second fluids may be mixed to form a mixed fluid with a supersaturation level greater than that of the first fluid. In some embodiments, the increase in supersaturation may cause the precipitation of particles (e.g., nucleation of crystals) from the mixed fluid.

In some embodiments, particles formed within a microfluidic channel may remain flowing in a microfluidic channel after they are formed. For example, in embodiments in which a pressure drop is achieved by the expansion of the cross sectional area of the channel, a portion of the channel downstream of the region of particle formation may be microfluidic. In some embodiments, the formed particles may be flowed in a microfluidic channel for a length at least about 2, at least about 5, at least about 10, at least about 25, at least about 50, or at least about 100 times the largest cross-sectional dimension of the microfluidic channel at the point of mixing.

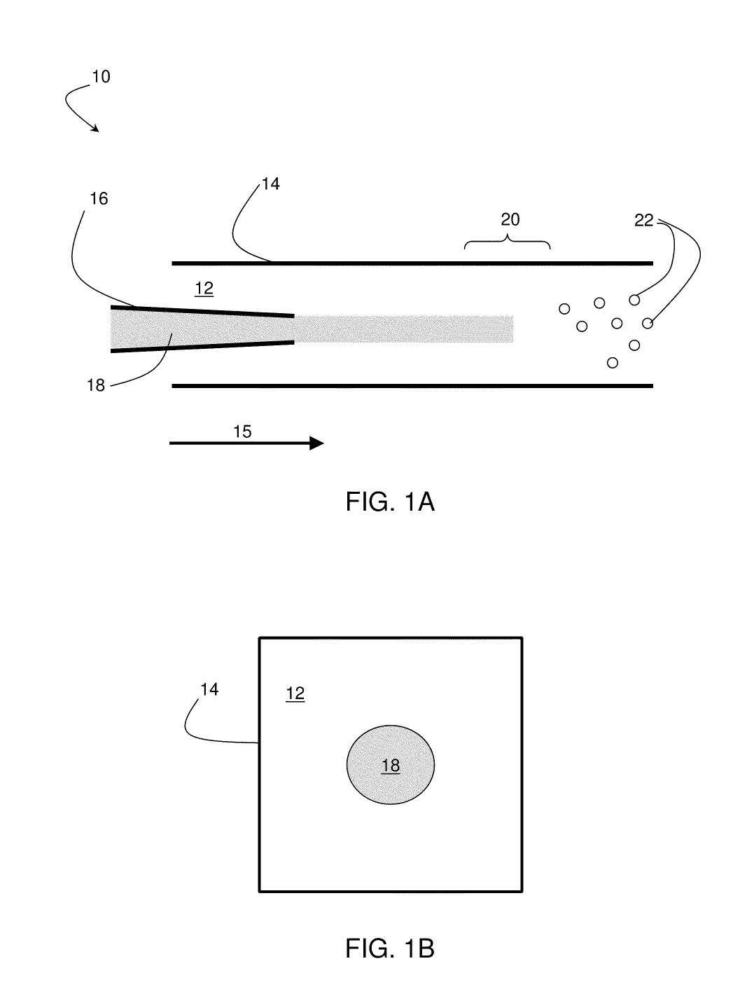

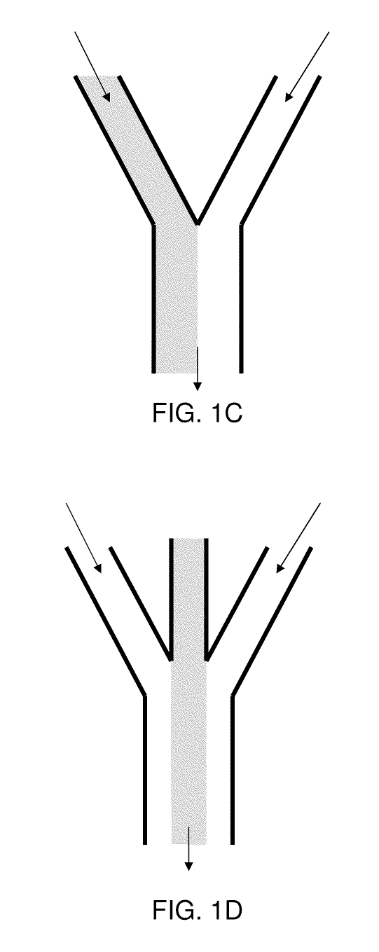

The first and second fluids (and optionally, additional fluids) may be combined and mixed using any suitable type of flow arrangement. In some embodiments, the first and second fluids are transported through a microfluidic channel via sheath flow. The term “sheath flow” is one that is recognized in the art and refers to a flow regime in which a first continuous stream of fluid (i.e. a core fluid) is surrounded by a second distinct fluid (i.e. a cladding fluid) forming a continuous fluid-fluid interface between the two. Sheath flow may be achieved, for example, using hydrodynamic flow focusing, as illustrated by system 10 in FIG. 1A. In FIG. 1A, a cladding fluid 12 is flowed through a first microfluidic channel 14 in the direction of arrow 15. A second microfluidic channel 16 (e.g., a capillary tube, needle, or the like) is disposed within the first microfluidic channel. As a second fluid 18 exits the second microfluidic channel, it forms a continuous core fluid surrounded by the cladding fluid, thus forming sheath flow. Within region 20, downstream of the formation of the sheath flow, the core and cladding fluids mix such that the interface between the fluids is no longer observed. After the first and second fluids are mixed, particles 22 are formed. FIG. 1B includes a schematic illustration of a cross section of channel 14 in FIG. 1A, showing the core-sheath arrangement of fluids 12 and 18.

In some embodiments, both the core and cladding fluids can be supercritical fluids, while in other embodiments one of the core and cladding fluids can be a supercritical fluid. In addition, in some embodiments the core fluid comprises antisolvent and the cladding fluid contains particle precursor. In some cases, the cladding fluid comprises antisolvent while the core fluid contains particle precursor. The use of sheath flow may improve mixing between two fluids, in some cases, due to the relatively large interfacial surface area between the fluids.

Other types of flow arrangements may also be used to mix the first and second fluids. For example, in some embodiments, two streams may be mixed by combining the to streams at a junction, as shown in FIG. 1C. In some cases, two-dimensional sheath flow may be achieved by combining three streams of fluid at a three-way junction, wherein a middle fluid is sandwiched between two streams of an outer fluid (which may be the same or different fluids), as shown in FIG. 1D. Bubbling flow or slug flow may also be used in some cases. One of ordinary skill in the art will be able to select an appropriate flow scheme for a given application.

The particles described herein may comprise a variety of materials. A particle may consist essentially of a single species, or it may comprise a mix of species (e.g., a co-crystal, an amorphous particle with multiple species, etc.). In some embodiments, a particle may be substantially crystalline (i.e., crystals), substantially amorphous, or a mixture of substantially crystalline and substantially amorphous species. In some embodiments, a particle may be substantially organic, substantially inorganic, or comprise a mixture of at least one organic and at least one inorganic species. A particle may be a crystalline polymorph, in some cases, or a pseudo-polymorph (e.g., a solvate or a hydrate form). In some instances, a particle may comprise a solid form of an active pharmaceuticals (e.g. ibuprofen, celcoxib, rofecoxib, valdecoxib, naproxen, meloxicam, aspirin, diclofenac, hydrocodone, propoxyphene, oxycodone, codeine, tramadol, fentanyl, morphine, meperidine, cyclobenzaprine, carisoprodol, metaxalone, chlorpheniramine, promethazine, methocarbamol, gabapentin, clonazepam, valproic acid, phenytoin, diazepam, topiramate, sumatriptan, lamotrigine, oxcarbanepine, phenobarbital, sertraline, paroxetine, fluoxetine, venlafaxine, citalopram, bupropion, amitriptyline, escitalopram, trazodone, mirtanapine, zolpidem, risperidone, olanzapine, quetiapine, promethazine, meclizine, metoclopramide, hydroxyzine, zaleplon, alprazolam, lorazepam, amphetamine, methylphenidate, temazepam, donepexil, atomoxetine, buspirone, lithium carbonate, carbidopa, amoxicillin, cephalexin, penicillin, cefdinir, cefprozil, cefuroxime, ceftriaxone, vancomycin, clindamycin, azithromycin, ciprofloxacin, levofloxacin, trimethoprim, clarithromycin, nitrofurantoin, doxycycline, moxifloxicin, gatifloxacin, tetracycline, erythromycin, fluconazole, valacyclovir, terbinafine, metronidazole, acyclovir, amphotericin, metformin, glipizide, pioglitazone, glyburide, rosiglitazone, glimepiride, metformin, octreotide, glucagon, insulin, human insulin NPH, glargine (insulin), lispro (insulin), aspart (insulin), levothyroxine, prednisone, allopurinol, methylprednisolone, liothyronine, somatropin, colchicine, sulfamerazine, lovastatin, caffeine, cholesterol, lidocaine, strimasterol, theophyllin, acetaminophen, albumin, sporanic acid, lysozyme, mefenamic acid, paracetamol, salmeterol xinafoate, salbutamol, cambamazepine, pyrene, progesterone, salicylic acid, stigmasterol, testosterone, theophyllin, tropic acid ester, flavone, tetracycline, derivatives or parents of the above-mentioned compounds, etc.), protein drugs (e.g. interferon, leuprolide, infliximab, trastuzumab, filgastrim, goserelin etc.) pigments (e.g., bronze red, quinacridone etc.), polymers and biopolymers (e.g. krytoxdiamide of hexamethylene (KRYTOX), polycaprolactone, poly(carbosilane), poly(2-ethylhexyl acrylate), poly(heptadecafluorodecylacrylate), poly-1-lactic acid (1-PLA), poly(methylmethacrylate), poly(phenyl sulfone), polypropylene, polystyrene, poly(vinyl chloride), ALAFF (ester of alginic acid), dextran, ester of pectinic acid, HPMA (poly(hydroxypropylmethacrylamide)), HYAFF 7 (ethyl ester of hyaluronic acid), HYAFF 11 (hyaluronic acid ethyl ester), HYAFF 11 p75, DL-PLA, DL-PLG, PLGA, polyacrylonitrile, polycaprolactone, poly(methacrylated sebacic anhydride) (methylene chloride)), small organic molecules (e.g. glycine, glutamic acid, methionine, flufenamic acid etc.), or explosives (e.g. cyclotrimetylenetri-nitramine, nitroguanidine, beta-HMX, NTO etc.), among others.

The species contained within a particle may be relatively small in some cases (e.g., aspirin, sulfamerazine, etc.) or relatively large (e.g., proteins). In one set of embodiments, particles may comprise an enzyme such as lysozyme. A particle may also comprise an encapsulant material (e.g., a biodegradable polymer, stabilizer, and the like, or combinations thereof) in some embodiments.

Particles produced using the systems and methods described herein may be very small. Not wishing to be bound by any theory, small particles may be formed due to rapid decreases in solubility of the particle precursor within the microfluidic channel fluid. The rapid drop in solubility may allow for a large amount of nucleation within a short period of time, therefore depleting the amount of particle precursor within the channel before particle growth can occur. Rapid decreases in solubility may be achieved, for example, by rapidly mixing a first fluid containing a particle precursor with a second fluid containing an antisolvent. A rapid drop in solubility of a particle precursor in a fluid may also be achieved by rapidly expanding the cross sectional area of the microfluidic channel, or by rapidly decreasing the temperature of the fluid, for example. In some embodiments, the average maximum cross-sectional dimension of a plurality of particles is less than about 10 microns, less than about 5 microns, less than to about 1 micron, less than about 500 nm, less than about 100 nm, or smaller. As used herein, the “maximum cross-sectional dimension” refers to the largest distance between two opposed boundaries of an individual structure that may be measured. The “average maximum cross-sectional dimension” of a plurality of structures is the arithmetic average of the maximum cross-sectional dimensions of each of the structures. Generally, “micro-scale” is used to refer to particles with maximum cross-sectional dimensions of less than about 1 mm, while “nano-scale” is used to refer to particles with maximum cross-sectional dimensions of less than about 1 micron.

In some embodiments, the particles produced in the microfluidic channel may be substantially the same shape and/or size (“monodisperse”). For example, organic particles may have a distribution of dimensions such that the standard deviation of the maximum cross-sectional dimensions of the particles is no more than about 100%, no more than about 75%, or no more than about 60%, or no more than about 40% of the average maximum cross sectional dimensions of the particles. Inorganic particles may have a distribution of dimensions such that the standard deviation of the maximum cross-sectional dimensions of the particles is no more than about 100%, no more than about 75%, or no more than about 50%, or no more than about 20% of the average maximum cross sectional dimensions of the particles. Standard deviation (lower-case sigma) is given its normal meaning in the art, and may be calculated as:

$$σ = \sqrt{\frac{{\sum }_{i = 1}^{n} {( {D}_{i} - {D}_{avg} )}^{2}}{n - 1}}$$

wherein Dᵢ is the maximum cross-sectional dimension of particle i, D_{avg} is the average of the cross-sectional dimensions of the particles, and n is the number of particles.

The particles produced using the systems and methods described herein may be collected and used in a variety of applications. For example, in some cases, the particles may be used as crystal seeds in crystal growth processes. In some embodiments, the particles may be administered as pharmaceutical agents. The particles produced in the microfluidic channel may be collected using any suitable method. For example, the particles may be collected in a filter at an exit of a channel In some embodiments, the particles may be extracted with another fluid in which the particles are not soluble. In some embodiments, the position of the particles within a microfluidic stream may be manipulated, for example, via flow focusing or another suitable technique. Once positioned, the particles may be separated from the bulk fluid using, for example, a T-junction, a baffle within the channel, or the like.

In some embodiments, one or more properties of a particle may be determined in at least one location in the microfluidic channel Examples of properties of a particle that may determined include, but are not limited to, a dimension (e.g., diameter, longest dimension, length, distance between crystal planes, or any other dimension), size distribution, shape, one or more angles between crystal planes, and crystallographic orientation (e.g., morphology of a single crystal, morphologies of multiple crystals in a co-crystal, morphologies of multiple crystals in a collection of separate crystals, etc.), morphologic composition, material composition of the particles (e.g. when used with co-crystals, impurities etc.), among others. In some embodiments in which the particles comprise crystals, the morphologic composition of a single crystal (i.e., the percentage (e.g., weight percentage) of each morphology type within a single crystal) may be determined

In some embodiments, a property (e.g., a dimension, etc.) of each of a plurality of particles may be determined, which may be used to determine a property of the plurality of particles (e.g., size distribution, morphology distribution, etc.). For example, in some embodiments in which the particles comprise crystals, the morphologic composition of a plurality of crystals may be determined The morphologic composition of a plurality of crystals may be determined by calculating the relative amounts of each morphology type among the plurality of crystals. For example, if 10 crystals are present, 4 with a first morphology and 6 with a second morphology, the morphologic composition, by number, would be 40% for the first morphology and 60% for the second morphology. Morphologic composition may also be calculated, in some cases, on a mass basis. It should be noted that the morphologic composition of a plurality of crystals can also be calculated when one or more crystals comprises multiple crystal morphologies. For example, if 10 crystals of equal mass are present, 4 with a 50%/50% (by mass) mix of first and second morphologies and 6 including only the second morphology, the morphologic composition of the plurality of crystals, by mass, would be 20% for the first morphology and 80% for the second morphology.

In some embodiments, at least one property of a particle, comprising a species, is determined in a channel, and, based upon the particle determination step, at least one condition for formation of a particle of the species is determined. Examples of conditions that may be determined include, for example, a temperature of a fluid or channel, a pressure within a channel, the concentration and/or composition of a species (e.g., a particle precursor, antisolvent, an impurity, etc.) within a fluid, the pH of a fluid, etc. Once the condition has been identified, some embodiments may further comprise forming particles comprising the species involving at least the condition. For example, in some embodiments, the crystallographic orientation of a crystal may be determined (e.g., to determine polymorphic type) in a microfluidic channel along which a pressure drop has been produced. It may be determined that the pressure drop in the channel produces crystals with a particularly desirable crystallographic orientation. The pressure profile may be used in subsequent crystal growth processes (e.g., experimental process, industrial production processes, etc.). As another example, the average maximum cross-sectional dimension of a plurality of particles may be determined in a channel operated at a temperature. The temperature may be used in subsequent particle growth processes to achieve the desired particle size distribution.

The term “determining,” as used herein, generally refers to the analysis or measurement of a species (e.g., a particle, a particle precursor, a fluid, an impurity, etc.), a property (e.g., a dimension, size distribution, crystallographic orientation, morphology, shape, morphologic composition, etc.), or condition (e.g., flow rate, temperature, pressure, etc.), for example, quantitatively or qualitatively, and/or the detection of the presence or absence of the species, property, or condition. Examples of suitable techniques include, but are not limited to, spectroscopy such as infrared, absorption, fluorescence, UV/visible, FTIR (“Fourier Transform Infrared Spectroscopy”), or Raman; gravimetric techniques; ellipsometry; piezoelectric measurements; immunoassays; electrochemical measurements; optical measurements such as optical microscopy or optical density measurements; circular dichroism; light scattering measurements such as quasielectric light scattering; polarimetry; refractometry; or turbidity measurements. In some embodiments, at least a portion of the device in which particle formation occurs is transparent to at least one wavelength of electromagnetic radiation (e.g., x-rays, ultraviolet, visible, IR, etc.) allowing interrogation of the particle. For example, optical microscopy may be used to determine one or more particle properties such as a dimension, shape, the presence or absence of a particle, etc. The systems used to determine a property of the particles may be interfaced with a computer to allow for real-time analysis. For example, images of particles may be analyzed in real time using image analysis software. This may allow for on board for real-time determination of nucleation kinetics, which may be used in subsequent processes to enhance particle formation.

As used herein, the term “fluid” generally refers to a substance that tends to flow and to conform to the outline of its container. Typically, fluids are materials that are unable to withstand a static shear stress, and when a shear stress is applied, the fluid experiences a continuing and permanent distortion. The fluid may have any suitable viscosity that permits at least some flow of the fluid. Non-limiting examples of fluids include liquids, gases, and supercritical fluids, but may also include free-flowing solid particles (e.g., colloids, vesicles, etc.), viscoelastic fluids, and the like.

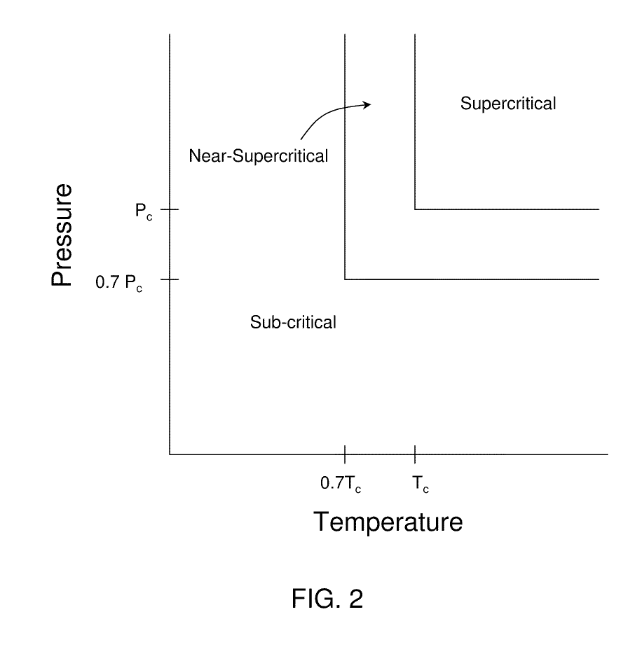

A “supercritical fluid” refers to any fluid at a temperature and pressure above its critical point. In any of the embodiments described herein, a near-supercritical fluid may be, in some instances, substituted for a supercritical fluid. A “near-supercritical” fluid refers to any fluid wherein one of the temperature and pressure is between about 0.7 and about 1 time its critical value, and the other of the temperature and pressure is above about 0.7 times the critical value. FIG. 2 includes a diagram outlining the near-supercritical and supercritical regimes.

A “channel,” as used herein, means a feature on or in an article (substrate) that at least partially directs the flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more typically at least 3:1, 5:1, or 10:1 or more. The “cross-sectional dimension” of a channel is measured perpendicular to the direction of fluid flow.

The channel may be of any size, for example, having a largest cross-sectional dimension of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flow rate of fluid in the channel. In some embodiments, the length of the channel may be selected such that the residence times of a first and second (or more) fluids at a predetermined flow rate are sufficient to produce organic materials of a desired size or crystallographic orientation. Lengths, widths, depths, or other dimensions of channels may be chosen, in some cases, to produce a desired pressure drop along the length of a channel (e.g., when a fluid of known viscosity will be flowed through one or more channels). Of course, the number of channels and the shape of the channels can be varied by any method known to those of ordinary skill in the art.

In some, but not all embodiments, some or all components of the systems and methods described herein are microfluidic. “Microfluidic,” as used herein, refers to a device, apparatus or system including at least one fluid channel having a largest cross-sectional dimension of less than about 1 mm, and a ratio of length to largest cross-sectional dimension perpendicular to the channel of at least 3:1. A “microfluidic channel” or a “microchannel” as used herein, is a channel meeting these criteria. In one set of embodiments, all fluid channels containing embodiments of the invention are microfluidic.

In some cases, multiple sets of microfluidic channels are fabricated on a single substrate (e.g., a silicon wafer) which may be designed to handle multiple sets of fluidic inlets for parallel testing of channel intersection designs. The effects of various design parameters such as channel dimensions, channel shape, and the ratio of the dimensions of two or more channels may be simultaneously tested. One or more designs that produce one or more favorable properties (e.g., crystal size distribution, polymorphic form, etc.) may be chosen for subsequent fabrication.

A variety of materials and methods, according to certain aspects of the invention, can be used to form systems such as those described above. In some embodiments, the channel materials are selected such that the interaction between one or more channel surfaces and a particle and/or particle precursor material is minimized Minimizing such interactions may assist in reducing the amount of particle nucleation on and/or attachment to walls of the channel, thus minimizing channel clogging. For example, when particles and/or particle precursors comprise charged particles, the channel material may be selected such that the charged materials are repelled from the channel surface. In some cases, one or more channel surface portions may be coated with a material that serves to minimize the interactions between the channel surface portion(s) and the particles and/or particle precursor materials within the channel For example, channels may be coated with a hydrophobic material to repel water-soluble particles. Similarly, channels may be coated, in some embodiments, with hydrophilic material to repel water-insoluble particles. For example, silicon channels, which are hydrophilic, may not interact very much with aspirin, a hydrophobic active ingredient. In another case, for example, fluorosilane-coated channels, which are hydrophobic, may not interact very much with glycine, a hydrophilic organic compound.

In some embodiments, the fluid channels may comprise tubing such as, for example, flexible tubes (e.g., PEEK tubing), capillary tubes (e.g., glass capillary tubes), and the like. In some embodiments, various components can be formed from solid materials, in which microfluidic channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one set of embodiments, at least a portion of the fluidic system is formed of silicon by etching features in a silicon chip. Enclosed channels may be formed, for example, by bonding a layer of material (e.g., polymer, Pyrex®, etc.) over the etched channels in the silicon. Technologies for precise and efficient fabrication of various fluidic systems and devices of the invention from silicon are known. In another embodiment, various components of the systems and devices of the invention can be formed of a polymer, for example, poly(dimethylsiloxane) (PDMS), PMMA, PTFE, PEEK and Teflon, cyclic olefin copolymers (COC) such as TOPAS. In some cases, various components of the system may be formed in other materials such as metal, ceramic, glass, Pyrex®, etc. In some embodiments, various components of the system may be formed of composites of these materials herein.

Different components can be fabricated of different materials. For example, a base portion including a bottom wall and side walls can be fabricated from a transparent or at least partially transparent material, such as glass or a transparent polymer, for observation and/or control of the fluidic process, and a top portion can be fabricated from an opaque material such as silicon. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 85° C. for exposure times of, for example, about two hours. Also, silicone polymers, such as PDMS, can be elastomeric, and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and to Polydimethylsiloxane,” Anal. Chem., 70:474-480, 1998 (Duffy, et al.), incorporated herein by reference.

In some embodiments, certain microfluidic structures of the invention (or interior, fluid-contacting surfaces) may be formed from certain oxidized silicone polymers. Such surfaces may be more hydrophilic than the surface of an elastomeric polymer. Such hydrophilic channel surfaces can thus be more easily filled and wetted with aqueous solutions.

In one embodiment, a bottom wall of a microfluidic device of the invention is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, bonding, solvent bonding, ultrasonic welding, etc.

The following examples are intended to illustrate certain embodiments of the present invention, but do not exemplify the full scope of the invention.

### Example 1

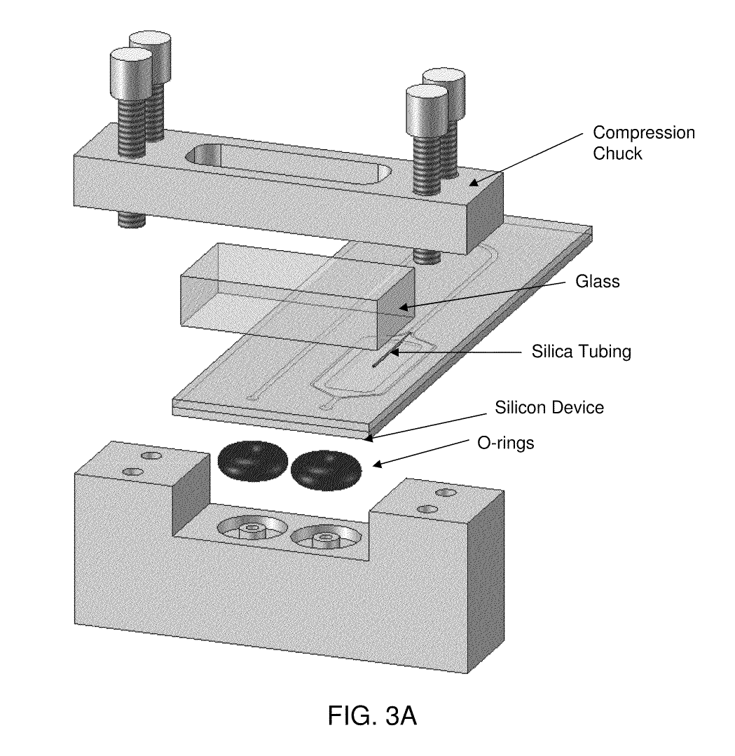

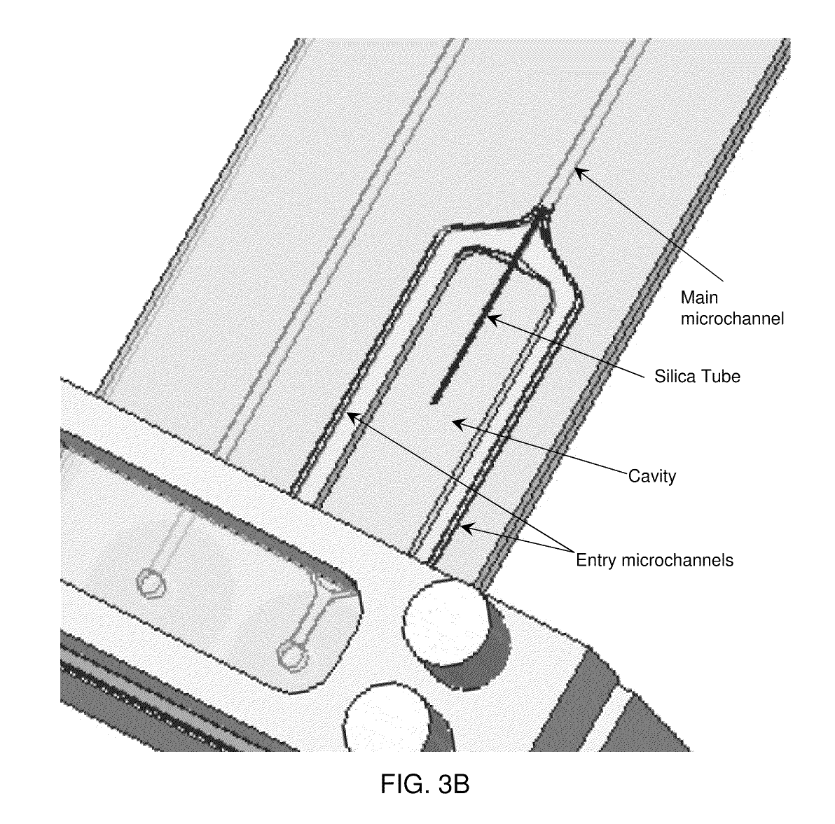

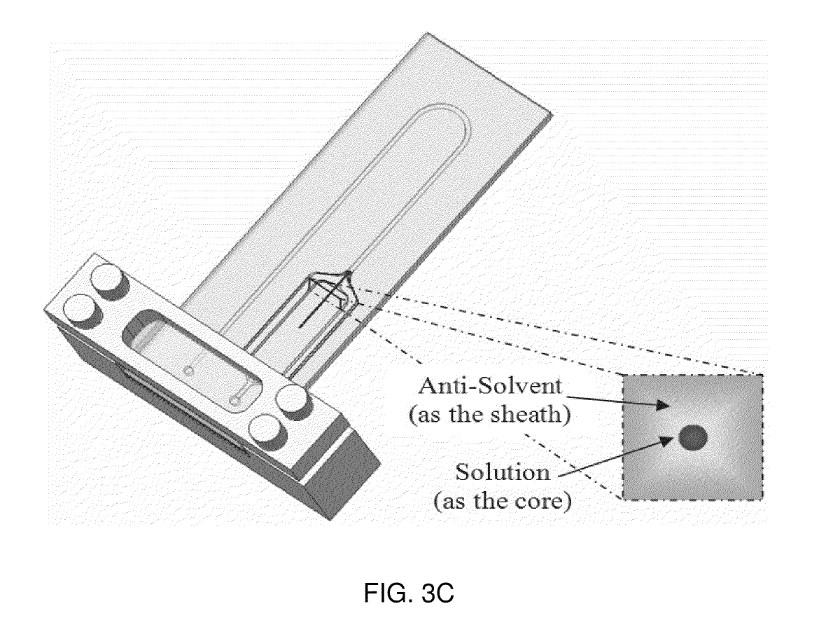

This example describes the formation of aspirin crystals, according to one set of embodiments. FIG. 3A outlines the packaging of the microfluidic channel device used in this example. The device was fabricated by deep reactive-ion etching (DRIE) of microfluidic channels into a silicon wafer. The microfluidic channels were approximately 600 microns wide, and 250 microns deep. A backside etch was performed to form port holes in fluid communication with the microfluidic channels. An oxidation step was performed to form a SiO₂ coating on the wafer (including the exposed walls of the channels). To enclose the channels, a Pyrex® wafer was bonded to the silicon (anodic bond, 350° C., 600-800 V).

Fluidic connections were made between a compression chuck and the inlet and outlet of the device using O-rings to ensure there was no leakage in the system. On the other side of the chip, a glass window was positioned between the top of the compression chuck and the device.

FIG. 3B includes a schematic diagram illustrating the intersection of multiple channels in the device. A silica tube was inserted into the device via a cavity. The tube was positioned within the device such that, when fluid was flowed within the tube and the entry microchannels etched into the silicon, sheath flow was observed within the main microchannel.

Antisolvent crystallization was used to produce micron-sized aspirin crystals with a narrow size distribution. As shown in FIG. 3C, supercritical CO₂ was used as the antisolvent and transported as the sheath fluid. The use of CO₂ provided several advantages as it is inexpensive, less toxic than conventional solvents, and relatively easy to remove. In addition, CO₂ has good transport properties and has a low critical pressure and temperature. Ethanol (which was transported as the core fluid) was used as the solvent as it is miscible with supercritical CO₂ and aspirin was readily soluble in it. Various concentrations of aspirin in ethanol were used at flow rates between 5 microliters/min and 20 microliters/min CO₂ flow rates varied between 500 microliters/min and 1500 microliters/min The device was operated at temperatures between 45° C. and 70° C., depending upon the flow rate ratio of the solvent and the antisolvent. The device was operated at a pressure above 85 bar. To ensure that the experiments were performed in the supercritical regime, the mixing region of the device was observed.

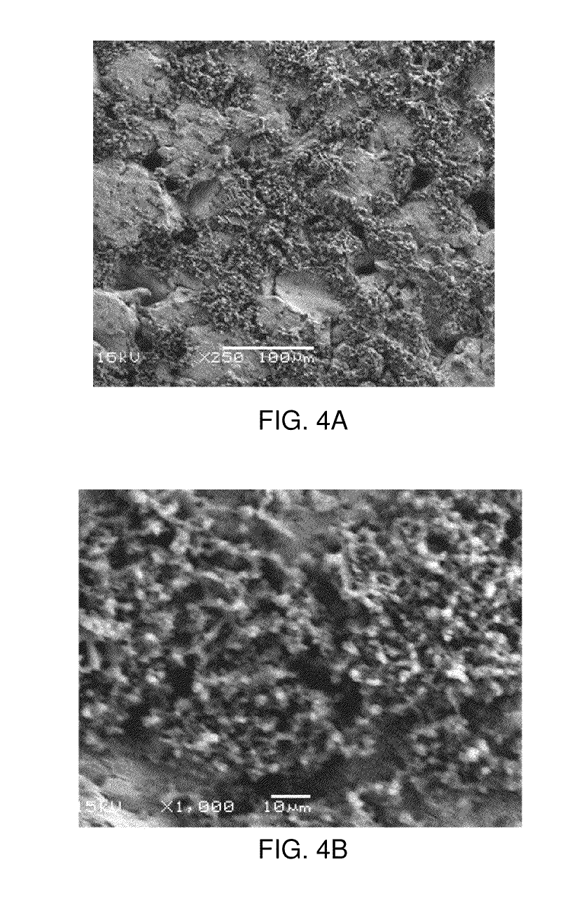

Crystallization was run for hours without clogging the channels. The product was collected using a filter at the outlet. Pure CO₂ was flowed over the products to remove residual solvent and to produce a dry sample upon depressurization. The sample was then characterized with scanning electron microscopy and transmission electron microscopy. As shown in FIGS. 4A-4B, 2 to 4 micrometer fines of aspirin were produced with a narrow size distribution.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion to of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of and “consisting essentially of shall be closed or semi-closed transitional phrases, respectively, as set forth in the United States Patent Office Manual of Patent Examining Procedures, Section 2111.03.

What is claimed is:

1. A method of forming organic particles, comprising:
flowing a first fluid containing an organic particle precursor within a microfluidic channel; and
flowing a second fluid within the microfluidic channel such that the second fluid contacts the first fluid in the microfluidic channel to form organic particles, wherein:
at least one of the first fluid and the second fluid is a supercritical fluid, and
after contact, the first and second fluids remain flowing in a microfluidic to channel.

2. The method of claim 1, wherein the second fluid comprises an antisolvent.

3. The method of claim 2, wherein the antisolvent is soluble in the first fluid.

4. The method of claim 1, wherein the organic particles are crystalline.

5. The method of claim 1, wherein the organic particles are amorphous.

6. The method of claim 1, wherein the organic particles comprise a polymer.

7. The method of claim 1, wherein the first fluid is a supercritical fluid.

8. The method of claim 1, wherein the second fluid is a supercritical fluid.

9. The method of claim 1, wherein the first and second fluids are transported through the microfluidic channel via sheath flow.

10. The method of claim 1, wherein the first fluid contains an organic crystal precursor dissolved in a solvent.

11. The method of claim 1, wherein the length of the microfluidic channel through which the mixed fluid is flowed is at least about 2 times the largest cross-sectional dimension of the microfluidic channel at the point of mixing.

12. The method of claim 1, wherein the organic particles have an average maximum cross-sectional dimension of less than about 10 microns.

13. The method of claim 1, wherein the organic particles are formed continuously.

14. A method, comprising:
flowing a supercritical fluid within a microfluidic channel;
mixing the supercritical fluid with a second fluid within the microfluidic channel to produce a mixed fluid; and
flowing the mixed fluid within the microfluidic channel

15. The method of claim 14, wherein the length of the microfluidic channel through which the mixed fluid is flowed is at least about 2 times the largest cross-sectional dimension of the microfluidic channel at the point of mixing.

16. A method of forming organic particles, comprising:
flowing a fluid containing an organic particle precursor within a microfluidic channel;
changing at least one condition such that the fluid crosses a threshold involving a supercritical state, resulting in the formation of organic particles; and
flowing the particles within the microfluidic channel

17. The method of claim 16, wherein the condition is the temperature of the supercritical fluid.

18. The method of claim 17, wherein changing at least one condition comprises lowering the temperature of the supercritical fluid to a value below its critical temperature.

19. The method of claim 16, wherein the condition is the pressure within the microfluidic channel.

20. The method of claim 19, wherein changing at least one condition comprises lowering the pressure of the supercritical fluid to a value below its critical pressure.

21. The method of claim 16, wherein the organic particles comprise crystals.

22. The method of claim 16, wherein the particles are flowed in the microfluidic to channel for a length at least about 2 times the largest cross-sectional dimension of the microfluidic channel at the point of mixing.

23. The method of claim 16, wherein the fluid is in a supercritical state upon entering the microfluidic channel.

24. The method of claim 16, wherein crossing a threshold involving a supercritical state comprises changing from a non-supercritical fluid to a supercritical fluid.

25. The method of claim 16, wherein crossing a threshold involving a supercritical state comprises changing from a supercritical fluid to a non-supercritical fluid.
